(19) United States
(12) Patent Application Publication
(10) Pub. No.: US 2005/0199533 A1
(43) Pub. Date: Sep. 15, 2005

(54) Centrifuge purification filter apparatus and method

(75) Inventors: Andrew Samways, Dorchester (GB); John L. Mills, Ilminster (GB)

Correspondence Address: CROWELL & MORING LLP;INTELLECTUAL PROPERTY GROUP, P.O. BOX 14300, WASHINGTON, DC, 20044-4300, US

(73) Assignee: Mann & Hummel GmbH, Ludwigsburg (DE)

(21) Appl. No.: 11/078,733

(22) Filed: Mar. 14, 2005

Related U.S. Application Data
(60) Provisional application No. 60/552,737, filed on Mar. 15, 2004.

(51) Int. Cl. B01D 35/00

(52) U.S. Cl. 210/97; 494/36; 210/110; 210/360.1

(57) ABSTRACT

A centrifuge purification filter is provided for purifying a fluid, such as engine lubricating oil. A housing with an integrally cast top portion contains a centrifuge rotor supported on a spindle, which in turn is supported at its top by the integrally formed housing top and retained and radially supported at its opposite end by a removable housing cover. The rotor includes a shell which receives contaminated fluid from the housing inlet via a hollow bore in the spindle. Fluid is discharged through tangential rotor outlet nozzles on the rotor cause the shell to rotate at high speed and thereby cause contaminants in the fluid to migrate to the shell wall. The integrally formed housing top portion may include a bore intersecting the inlet passage, wherein a flow control valve prevents flow into the rotor until inlet pressure reaches a predetermined level and in the event of excessive inlet pressure.

### BACKGROUND AND SUMMARY OF THE INVENTION

The present invention relates to fluid purification, and in particular to centrifuge separation apparatus for separating contaminants from liquids, such as engine lubricants.

Centrifugal separation is well known for use in applications, such as in the lubrication systems of vehicle internal combustion engines, as an efficient means for removing contaminants from the constantly recirculating liquid, such as small particulate matter arising from abrasion of the metallic components of the engine, decomposition of the lubricant and accumulated products of combustion over a long period of operation.

An example of such centrifugal separation apparatus is shown in FIG. 1A. This type of centrifuge filter 1 is sometimes referred to as a sedimenting, solid-wall type in which separated solids are retained within a rotor housing 2 as a sediment against an impervious radially outer side wall thereof. Such centrifuge filters are distinct from the so-called filtering perforate-wall type in which the solids are held by the mesh of a perforate radially outer side wall while liquid passes therethrough. Due to the fact that the liquid to be cleaned is circulated at elevated pressure, the liquid pressure is in a centrifuge filter to effect rotation of parts responsible for generating centrifugal forces. Typically, a rotor 2 comprising an essentially closed vessel or canister is supported for rotation about a rotation axis 3 within a purification filter housing 4, and is supplied with the liquid to be purified at elevated pressure though a feed channel 5 which enters the rotor along the rotation axis 3. The rotor canister is filled with the liquid and assumes a significant internal pressure before liquid is forced from an outlet 6 at the base 7 or along another outer peripheral wall of the canister by way of directed jet reaction nozzles which have at least a tangential liquid velocity component. The reaction to the tangentially ejected liquid is to cause the rotor canister and liquid within it to spin at high speed about the rotation axis and thereby force solid particles and other heavy contaminant matter to migrate from the liquid passing through the canister and agglomerate into a cohesive mass on the peripheral walls spaced from the rotation axis. The reaction nozzles, being directed substantially tangentially with respect to the rotation axis, at least in a plane orthogonal to the axis, define a reaction turbine.

It will be appreciated that the efficiency of separation is dependant, inter alia, upon creating the conditions in which any liquid entrained particle or other heavy matter can migrate radially to the nearest deposition surface, and is a function of the force acting on such contaminant and the time for which it can act. The former is a function of rotation rate and distance from the rotation axis. The latter is a function of the time taken for the entraining liquid to pass through the rotor canister (also called the residence time) and the proximity of the deposition surface, and may be considered in terms of an effective residence time, that is, influencing the contribution of the actual residence time by positioning the contaminated liquid relatively to an appropriate deposition surface. Further, both the rotation speed of the rotor canister and contained liquid, and the rate at which liquid is passed through and ejected therefrom, are dependant upon the pressure drop between the canister contents and housing and upon the dimensions of the nozzles, within the constraints of such nozzle dimensions providing sufficient torque from the turbine to overcome inertial and frictional resistance to commencement of, and continuation of, rotation.

Within an internal combustion engine where lubricant is circulated under pressure in a range of about 2 to 6 bars that varies with operating conditions, a canister of relatively modest diameter, say 10 to 15 cm, and reaction turbine nozzles may achieve a rotation speed in the range of 4000 to 9000 r.p.m. which is sufficient for removing the relatively dense contaminants of lubricant residue and metallic particles traditionally considered to be of principal detriment to the engine. Examples of such reaction turbine centrifugal separation are shown in GB 745377, GB 2328891, U.S. Pat. No. 5,575,912 and U.S. Pat. No. 5,906,733. As can be seen from these examples, as developments have been made to increase efficiency of separation, and range of separability, the degree of structural complexity has also increased, with consequences of increased cost and, in some cases, increased complexity in equipment installation due to separator configuration requirements (e.g., housing size, shape, inlet and outlet placement).

FIG. 1A also illustrates a prior art spindle attachment arrangement which is complicated and costly to manufacture. In this prior art example, the centrifuge housing 4 is provided with a multi-part upper spindle anchor arrangement 12, including a separate spindle bushing 13, a bushing mounting plate 14, a housing end cover plate 15, and a plurality of sealing rings 16 to seal the inlet end of centrifuge housing. In addition to the additional costs associated with all these separate components, the additional plurality of sealing surfaces increase the potential for fluid leakage from the housing.

In view of the foregoing, it is an object of the present invention to provide an improved centrifugal purification apparatus and method with a simplified structure which reduces production costs.

Another object is to provide a centrifugal purification apparatus which permits a simplified mounting arrangement, such as flat inlet and outlet flanges.

A further object is to provide a purification apparatus which provides enhanced protection of equipment such as internal combustion engines by preventing lubricating fluid to be withdrawn from the equipment into the centrifugal purification apparatus until sufficient lubricating liquid pressure is present in the equipment, and preventing excessive flow from damaging the centrifuge rotor when inlet pressure is too high. It is a further object to provide such protection with an inlet flow control valve which is located within the centrifugal purification apparatus housing in a simple, low-cost manner which permits ready access to the valve for servicing.

A further object is to provide a simplified centrifugal purification apparatus housing in which structural elements such as a rotor spindle attachment fixture (such as a threaded boss) are formed directly in the centrifugal purification apparatus housing, without the need to include separate, costly inserts to perform the desired structural functions.

In one embodiment of the present invention, there is provided a centrifuge purification filter apparatus with a housing enclosing a purification volume. The housing includes an integrally formed top portion with a fluid inlet to feed a contaminated liquid to a central spindle rod attached to the integral housing top portion. The opposite end of the spindle is radially supported by a housing end cover which also closes off the bottom of the housing. The spindle is hollow at least between its inlet end affixed to the housing top portion and a transverse outlet bore part way down the spindle. Rotatably mounted on the spindle is a centrifuge rotor which includes a rotor shell and a base plate enclosing a centrifuge volume. The centrifuge volume receives the contaminated fluid entering the housing inlet via an inlet passage in fluid communication with the hollow portion of the spindle. The centrifuge rotor is made to rotate at high speed by release of fluid from a pair of tangentially-oriented nozzles in the rotor base plate. The rotating centrifuge rotor generates centrifuge forces on the fluid and entrained contaminants in the centrifuge volume, causing the contaminants to migrate radially outward through the fluid and accumulate at the inner surface of the rotor shell. The purified fluid passing out of the rotor outlet nozzles accumulates within the centrifuge housing outside the rotor shell and then passes out of the housing through an outlet port.

In addition to forming the centrifuge apparatus housing with an integral spindle connection surface, a flow control valve bore which intersects the fluid inlet passage also may be integrally formed in the housing top portion, and the bore provided with a flow control valve which limits fluid flow into the top of the spindle until a predetermined inlet pressure is reached and, when inlet pressure is undesirably high, further limits flow into the centrifuge rotor. This feature provides a centrifuge purification filter which contains integrated automatic low pressure protection of the equipment it serves and over-pressure protection of the centrifuge purification filter itself. Further, by orienting the flow control valve bore diametrically opposite the housing mounting flanges, such an arrangement eases maintenance (and thereby further lowers operating costs) by making the flow control valve accessible for service without requiring removal of the entire housing from its mounts.

In this embodiment the housing inlet and housing outlet are formed as flat, co-planar flanges which include laterally-extending portions to accommodate fasteners extending therethrough. The use of flat, coplanar flanges, preferably with simple, flat gaskets between the flanges and corresponding mating surfaces on, for example, an engine block, greatly simplifies centrifuge purification filter housing mounting as compared to prior art mounting systems. For example, as shown in FIG. 1A and in FIG. 1B (cross-section view of FIG. 1A at plane A-A), the prior art housing has a stub tube 8 welded to the filter housing outlet 9 designed to mate with a corresponding o-ring-equipped, precision-machined bore 10. As compared to the present invention's flat flanges, such a prior art connection arrangement requires extra component such as stub tubes, o-rings and receiving fittings, additional production operations such as precision bore machining and welding to join the component to the housing, and careful, time-consuming handling of the housing to properly aligned and guide stub tube 8 into precision bore 10 to avoid damage to o-ring 11 or the other flange components in order to provide a properly sealed connection. In contrast, the present invention's flat flanges are inexpensive to machine, do not require additional components to be procured, machined and/or welded, and permit the housing to be quickly placed into position and bolted to an engine, saving installation costs and time. Alternatively, a flat flange an each of the inlet and outlet, preferably co-planar, may be used with o-ring sealed stub tubes inserted into the inlet and outlet which mate with corresponding inlet and outlet ports on the equipment served by the centrifuge filter. Such an arrangement would ease installation by allowing simultaneous insertion of the stub tubes into their receiving ports, and eliminate the need for use of a gasket between the flat flange mating surfaces.

A further benefit of the present invention is its greatly simplified and more reliable inlet and spindle arrangements. By integrating the elements located at the top of the housing, such as the inlet passage, spindle attachment, and flow control valve and its bore, for example in a single housing casting, all of the additional components of the FIG. 1A prior art spindle attachment arrangement are eliminated, along with their component and installation costs and their additional potential for fluid leakage.

Other objects, advantages and novel features of the present invention will become apparent from the following detailed description of the invention when considered in conjunction with the accompanying drawings.

### BRIEF DESCRIPTION OF THE DRAWINGS

FIGS. 1A and 1B are vertical and horizontal cross-section views, respectively, of a centrifuge filter known in the prior art.

FIG. 2 is a cross-section of a centrifuge purification filter apparatus in accordance with an embodiment of the present invention.

FIG. 3 is a disassembled view of subassemblies of the centrifuge purification filter apparatus in accordance with the embodiment of the present invention shown in FIG. 2.

FIG. 4 is an oblique view of an outer surface of the housing of the centrifuge purification filter apparatus in accordance with the embodiment of the present invention shown in FIG. 2, illustrating this embodiment's flat, co-planar mounting flanges.

### DETAILED DESCRIPTION OF THE DRAWINGS

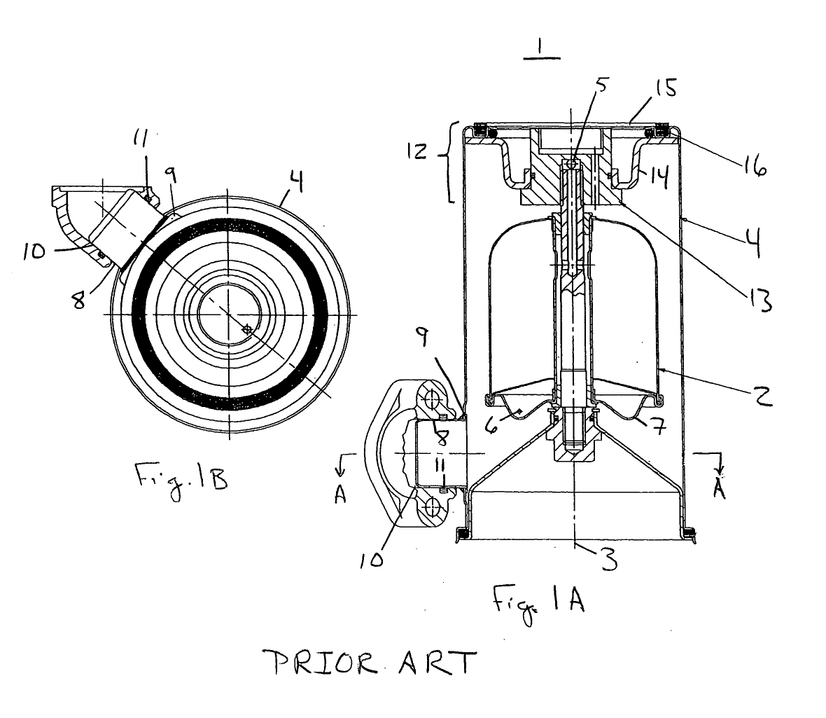

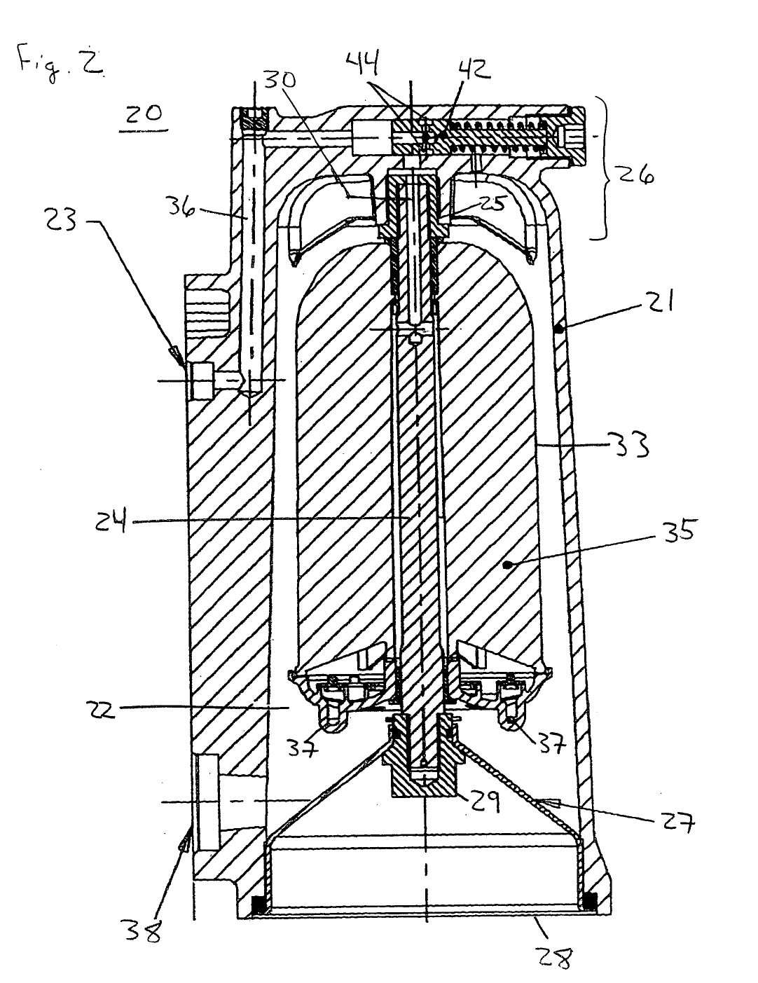

FIG. 2 is a first embodiment of the present invention, wherein a centrifuge purification filter apparatus 20 is provided a centrifuge purification filter apparatus with a housing 21 enclosing a purification volume 22. The housing includes a fluid inlet 23 to feed a contaminated liquid, in this embodiment, the lubricating oil of an engine, to a central spindle rod 24 attached to a threaded connection 25 either integrally formed in the integrally cast top portion 26 of the housing itself or, as shown in FIG. 1, formed in a bushing inserted into in the integrally formed top portion 26. The opposite end of the spindle is radially supported by a housing end cap 27. The housing end cap 27, which also closes off the bottom 28 of the housing, is retained by a nut 29 affixed to the spindle end.

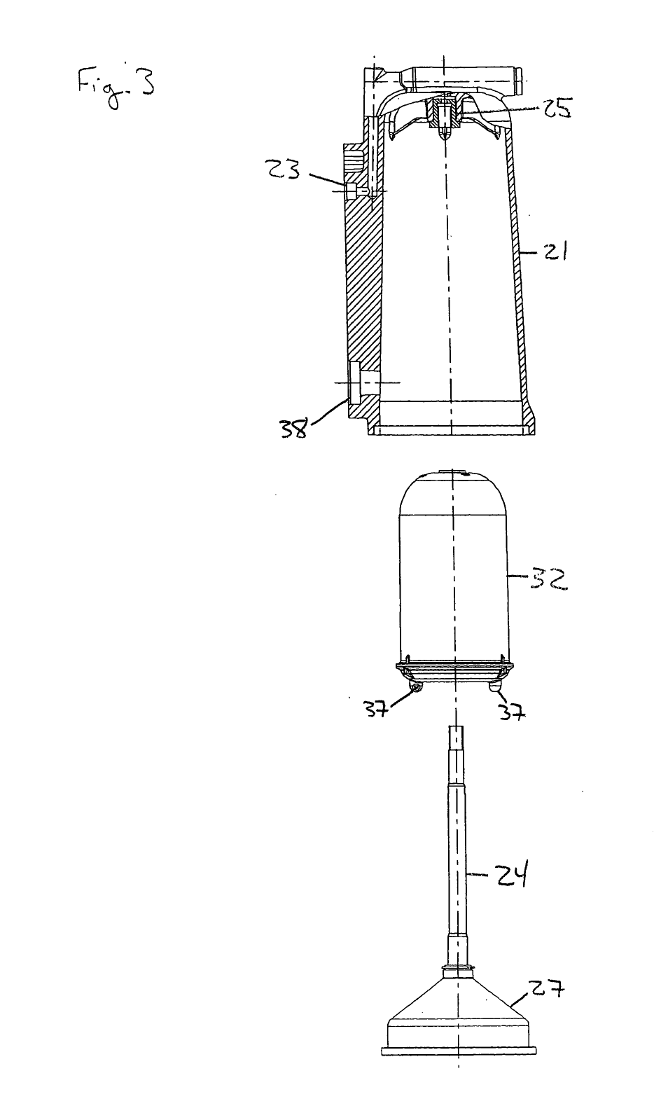

The spindle is hollow at least between its inlet end 30 and a transverse outlet bore 31 part way down its length. Rotatably mounted on the spindle is a centrifuge rotor 32 which includes a rotor shell 33 and a base plate 34 enclosing an inner centrifuge volume 35. Centrifuge rotor 32 is also shown in FIG. 3, which is an exploded view showing the major components of the present embodiment aligned along their axis of assembly, where spindle 24 affixed to end cap 27 receives centrifuge rotor 32, and the rotor/spindle assembly is inserted through the bottom of housing 21 (shown in cross-section view) and retained at internal threaded connection 25 at the top of housing 21 via external threads on spindle 24 extending above the top of centrifuge rotor 32.

Upon entry into housing inlet 23, the contaminated liquid is fed though inlet passage 36 to spindle inlet 30, through the hollow portion of the spindle to transverse outlet 31, and into centrifuge volume 35. At the rotor base plate 34 there are located a pair of tangentially-oriented nozzles 37 which serve as outlet nozzles for the liquid in centrifuge volume 35. The nozzles 37 are arranged such that the change in momentum of the liquid escaping from centrifuge rotor 32 into purification volume 22 causes the rotor to rotate about the spindle 24. The rotating centrifuge rotor 32 and the liquid contained therein reaches a high rotational velocity, thereby generating centrifuge forces on the liquid and contaminants in the centrifuge volume 35. The centrifuge forces cause the contaminants in the liquid to migrate radially outward and accumulate at the inner surface of the rotor shell 33.

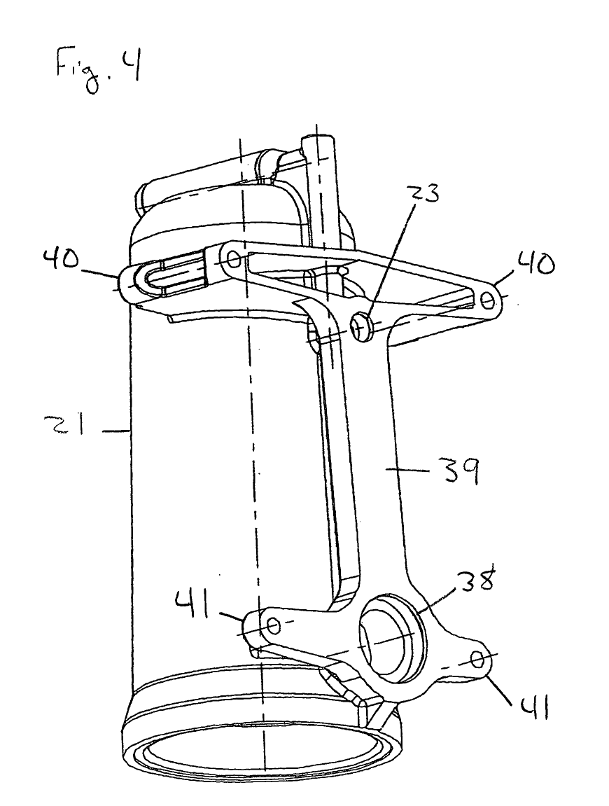

Once the purified liquid passes though the rotor outlet nozzles 37, it accumulates within the centrifuge housing 21 outside the rotor shell 32 and then passes out of the housing 21 through an outlet port 38 which, in this embodiment, is connected to a passage leading to the engine's oil sump (not illustrated). The housing inlet 23 and housing outlet 38 are formed with flat, coplanar flanges. In this embodiment, the inlet and outlet share a common flat flange 39, as shown in FIG. 4. The flanges include laterally-extending portions 40, 41 which accommodate fasteners extending therethrough to affix housing 21 to the engine against a corresponding flanges on the engine (not illustrated). The use of flat, coplanar flanges, optionally with simple, flat gaskets between the corresponding flange faces, greatly simplifies the mounting arrangements of the present invention centrifuge filter as compared to prior art mounting systems, saving machining, component and installation costs and time. As an alternative, the gaskets may be supplemented, or entirely replaced by o-ring-equipped stub tubes (not illustrated) located in the housing inlet and outlet and projecting outward to mate with corresponding bores in the engine's inlet and out ports.

In another embodiment of the present invention, in addition to integrally forming the fluid inlet passages and spindle connection into the top of the housing 21, there may also be located an integrally formed flow control valve which simply and simultaneously prevents fluid flow into the centrifuge rotor until fluid pressure has reached a predetermined level, and prevents over-pressure damage to internal components such as the centrifuge rotor.

As shown in FIG. 2, a spring-loaded flow control valve 42 is located in a bore 43 which intersects fluid inlet passage 36 upstream of spindle inlet 30. In this location, flow control valve 42 is positioned to prevent fluid flow from inlet passage 36 into spindle inlet 30 until the fluid pressure in passage 36 is sufficiently high to displace flow control valve 42 part way back into bore 43 to allow flow orifices 44 in valve 42 to align with spindle inlet 30 and thereby permit fluid to pass from inlet passage 36 into spindle inlet 30. Such an arrangement ensures that sufficient pressure is present in the fluid system, such as the oil lubrication system of an engine, before any fluid is allowed to be removed from the fluid system into the centrifuge rotor. Flow control valve further may be arranged such that when inlet fluid pressure reaches undesirably high levels, flow control valve 42 is displaced farther back into bore 43 until the valve's orifices 44 are no longer aligned with spindle inlet 30, thereby limiting fluid flow into spindle inlet 30, as illustrated in FIG. 2. This arrangement ensures that the centrifuge rotor may be isolated from excessively high inlet in order to prevent rotor damage. Preferably, the flow control valve bore 43 is oriented diametrically opposite the housing mounting flanges 40, 41 to permit in-situ access to the bore and the flow control valve for maintenance, etc.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A centrifuge purification filter, comprising:
a housing enclosing a purification volume, the housing including a fluid inlet, a fluid outlet and a removable end cover,
a spindle, wherein
a first end of the spindle is supported at an inlet end of the housing by a spindle support surface formed in the housing,
a second end of the spindle and the end cover are adapted to cooperate when installed in the housing to close an outlet end of the housing opposite the housing inlet end and to radially locate the second end of the spindle, and
the spindle is hollow at least between the first spindle end and a transverse spindle outlet bore; and
a centrifuge rotor supported along an axis of rotation by the spindle, the centrifuge rotor including
a rotor shell enclosing a centrifuge volume in fluid communication with the transverse spindle outlet bore,
an outlet nozzle oriented to cause the rotor shell to rotate about the axis of rotation in response to fluid flow through the outlet nozzle;
wherein the housing inlet is in fluid communication with the housing outlet via the hollow portion of the spindle and the centrifuge rotor outlet nozzle, and
wherein the housing inlet and housing outlet are located in flat flanges.

2. The centrifuge purification filter of claim 1, wherein
the flat inlet and outlet flanges are adapted to permit the housing to be affixed to corresponding inlet and outlet flanges on an internal combustion engine.

3. The centrifuge purification filter of claim 2, wherein
the housing inlet and housing outlet flanges are co-planar.

4. The centrifuge purification filter of claim 3, wherein
the housing inlet and housing outlet flanges include lateral mounting flanges extending transverse to a longitudinal axis of the housing a distance sufficient to permit fasteners to be inserted from a housing side through the lateral flanges.

5. The centrifuge purification filter of claim 2, further comprising
stub tubes extending outward from the housing inlet and the housing outlet perpendicular to the housing inlet and housing outlet flanges.

6. The centrifuge purification filter of claim 2, further comprising:
a flow control valve disposed in the inlet end of the housing to prevent fluid flow between the housing inlet and the spindle unless a fluid pressure in the inlet exceeds a predetermined pressure,
wherein the flow control valve is accessible from a side of the housing opposite a side containing the inlet and outlet flanges.

7. The centrifuge purification filter of claim 1, wherein
the spindle is affixed to the inlet end of the housing via a threaded connection, and the centrifuge rotor rotates about the spindle.

8. The centrifuge purification filter of claim 1, wherein
the centrifuge rotor is adapted retain contaminants removed from a fluid within the rotor shell as the fluid leaves the rotor outlet nozzle.

9. An internal combustion engine with a centrifuge purification filter, comprising:
a centrifuge purification filter including the housing inlet and housing outlet located in flat, co-planar flanges; and
an engine adapted to receive the centrifuge purification filter on flat flanges corresponding to the centrifuge purification filter housing inlet and outlet flanges.

10. The engine of claim 1, further comprising:
stub tubes extending outward from the housing inlet and the housing outlet perpendicular to the housing inlet and housing outlet flanges

11. A centrifuge purification filter housing, comprising:
a housing body enclosing a purification volume;
a housing body fluid inlet;
a housing body fluid outlet;
a spindle support formed in the housing body at an inlet end of the housing in fluid communication with the housing body fluid inlet; and
a bore in the inlet end of the housing configured to receive a flow control valve adapted to prevent fluid flow between the housing inlet and the spindle below a predetermined inlet fluid pressure,
wherein the housing inlet and housing outlet are located in flat flanges.

12. The centrifuge purification filter housing of claim 11, wherein
the flat inlet and housing outlet flanges are adapted to permit the housing to be affixed to corresponding inlet and outlet flanges on an internal combustion engine.

13. The centrifuge purification filter housing of claim 12, wherein
the housing inlet and housing outlet flanges are co-planar.

14. The centrifuge purification filter housing of claim 13, wherein
the housing inlet and housing outlet flanges include lateral mounting flanges extending transverse to a longitudinal axis of the housing body a distance sufficient to permit fasteners to be inserted from a housing side through the lateral flanges.

15. The centrifuge purification filter housing of claim 12, wherein
stub tubes extending outward from the housing inlet and the housing outlet perpendicular to the housing inlet and housing outlet flanges.

16. The centrifuge purification filter housing of claim 12, wherein
the bore configured to receive the flow control valve is arranged to permit the flow control valve to be accessible from a side of the housing body opposite a side containing the inlet and outlet flanges.

17. A method for centrifugal purification of a fluid, comprising the steps of:
providing a centrifuge purification filter, including
a housing enclosing a purification volume, the housing including a fluid inlet, a fluid outlet and a removable end cover, wherein the housing inlet and housing outlet are located in flat flanges,
a spindle, wherein
a first end of the spindle is supported at an inlet end of the housing by a spindle support surface formed in the housing,
a second end of the spindle and the end cover are adapted to cooperate when installed in the housing to close an outlet end of the housing opposite the housing inlet end and to radially locate the second end of the spindle, and
the spindle is hollow at least between the first spindle end and a transverse spindle outlet bore; and
a centrifuge rotor supported along an axis of rotation by the spindle, the centrifuge rotor including
a rotor shell enclosing a centrifuge volume in fluid communication with the transverse spindle outlet bore,
an outlet nozzle oriented to cause the rotor shell to rotate about the axis of rotation in response to fluid flow through the outlet nozzle;
wherein the housing inlet is in fluid communication with the housing outlet via the hollow portion of the spindle and the centrifuge rotor outlet nozzle; and
introducing a fluid into the housing inlet;
passing the fluid from the housing inlet through the hollow portion of the spindle and the transverse spindle outlet into the centrifuge rotor purification volume;
releasing the fluid from the rotor outlet nozzle to rotate the centrifuge rotor and the fluid therein to cause fluid contaminants to migrate radially outward to the rotor shell; and
passing the purified fluid from the rotor outlet nozzle to the housing outlet.

18. The method of claim 17, wherein
the centrifuge purification filter includes a flow control valve disposed in the inlet end of the housing to prevent fluid flow between the housing inlet and the spindle unless a fluid pressure in the inlet exceeds a predetermined pressure, and
the step of introducing a fluid into the housing inlet is performed at a fluid pressure above the predetermined pressure.
